(19) United States
(12) Patent Application Publication
(10) Pub. No.: US 2025/0303991 A1
(43) Pub. Date: Oct. 2, 2025

(54) VEHICLE FRONT STRUCTURE

(71) Applicant: TOYOTA JIDOSHA KABUSHIKI KAISHA, Toyota-ahi (JP)

(72) Inventor: Koji SAEKI, Okazaki-shi (JP)

(73) Assignee: TOYOTA JIDOSHA KABUSHIKI KAISHA, Toyota-shi (JP)

(21) Appl. No.: 19/019,959

(22) Filed: Jan. 14, 2025

(30) Foreign Application Priority Data
Mar. 27, 2024 (JP) 2024-052494

(51) Int. Cl. B60R 19/34; B60K 11/04; B62D 25/08

(52) U.S. Cl. CPC B60R 19/34; B62D 25/088; B60K 11/04

(57) ABSTRACT

The vehicle front structure includes a pair of front side members provided on both side portions in the vehicle width direction and extending in the vehicle front-rear direction, a bumper reinforcement that extends along the vehicle width direction and is connected in a state in which an end portion on the outer side in the vehicle width direction extends outward in the vehicle width direction beyond an end portion on the vehicle front side of the front side member, and a radiator that is provided between the pair of front side members and is arranged so as to overlap the end portion and the vehicle width direction in a state in which an end portion on the outer side in the vehicle width direction of the bumper reinforcement is bent and deformed by an input of a collision load from the vehicle front side.

### CROSS-REFERENCE TO RELATED APPLICATION

This application claims priority to Japanese Patent Application No. 2024-052494 filed on Mar. 27, 2024, incorporated herein by reference in its entirety.

### BACKGROUND

### 1. Technical Field

The present disclosure relates to a vehicle front structure.

### 2. Description of Related Art

Japanese Unexamined Patent Application Publication No. 2013-233820 (JP 2013-233820 A) discloses a structure including a connecting member that connects a pair of front side members in a vehicle width direction. In this structure, a load input from a bumper reinforcement in the vehicle width direction at the time of small overlap collision is transmitted to the connecting member to apply a reaction force due to bending rigidity in the vehicle width direction.

### SUMMARY

When the connecting member dedicated to the small overlap collision is provided between the front side members as in the technology described in JP 2013-233820 A, however, the cost of the member and the mass of the vehicle body increase.

The present disclosure provides a vehicle front structure capable of suppressing an increase in the cost of a member and the mass of a vehicle body, and efficiently releasing the vehicle from a collision body at the time of small overlap collision of the vehicle.

A vehicle front structure according to a first aspect of the present disclosure includes:
a pair of framework portions provided on both sides of a vehicle front portion in a vehicle width direction and extending in a vehicle front-rear direction;
a bumper reinforcement extending along the vehicle width direction and connected in a state in which outer ends in the vehicle width direction project outward in the vehicle width direction beyond ends of the framework portions on a vehicle front side; and a heat exchanger provided between the framework portions and disposed to overlap, in the vehicle width direction, the outer end of the bumper reinforcement in the vehicle width direction in a state in which the outer end is bent by input of a collision load from the vehicle front side.

In the vehicle front structure of the above aspect, the bumper reinforcement is connected to the ends on the vehicle front side for the framework portions extending in the vehicle front-rear direction. The bumper reinforcement extends along the vehicle width direction and is connected in the state in which the outer ends in the vehicle width direction project outward in the vehicle width direction beyond the ends of the framework portions on the vehicle front side.

The heat exchanger is provided between the framework portions. The heat exchanger is disposed to overlap, in the vehicle width direction, the outer end of the bumper reinforcement in the vehicle width direction in the state in which the outer end is bent by input of the collision load from the vehicle front side.

Therefore, when a collision load to the vehicle rear side is mainly input to the end of the bumper reinforcement in the vehicle width direction at the time of small overlap collision between the vehicle and a collision body, the end of the bumper reinforcement in the vehicle width direction is bent inward in the vehicle width direction. The end of the bumper reinforcement in the vehicle width direction comes into contact with one of the front side members. An inward component force of the collision load in the vehicle width direction is transmitted from the one front side member to the other front side member via the heat exchanger. As a result, a reaction force is generated at the contact portion between the front side member and the bumper reinforcement by utilizing the bending rigidity of the heat exchanger, and a lateral force to a side opposite to the collision side (inner side in the vehicle width direction) is applied to the vehicle front portion. Accordingly, the vehicle can be efficiently released from the collision body at the time of small overlap collision of the vehicle. By utilizing the bending rigidity of the heat exchanger known as a member mounted on the vehicle front portion, it is not necessary to add the connecting member dedicated to the small overlap collision. Therefore, it is possible to suppress the increase in the cost of the member and the mass of the vehicle body.

In the vehicle front structure of the above aspect, the outer ends of the bumper reinforcement in the vehicle width direction are provided with protruding portions that protrude to a vehicle rear side and to an inner side in the vehicle width direction.

In the vehicle front structure of the above aspect, a collision load to the vehicle rear side is mainly input to the end of the bumper reinforcement in the vehicle width direction at the time of small overlap collision between the vehicle and a collision body. Then, the protruding portion provided at the end of the bumper reinforcement in the vehicle width direction moves inward in the vehicle width direction and comes into contact with the front side member. Thus, an inward component force of the collision load in the vehicle width direction is rapidly transmitted from the one front side member to the heat exchanger via the protruding portion. As a result, the vehicle can be rapidly released from the collision body at the time of small overlap collision of the vehicle.

In the vehicle front structure of the above aspect,
the framework portions are each provided with, in an area located between the heat exchanger and the end of the bumper reinforcement in the vehicle width direction in a state in which the end is bent, a high rigidity portion having higher rigidity than rigidity of another area.

In the vehicle front structure of the above aspect, the framework portion is provided with the high rigidity portion in the area located between the heat exchanger and the bent end of the bumper reinforcement in the vehicle width direction. Therefore, the bending rigidity of the front side member is increased by the high rigidity portion at the ends of the front side member and the bumper reinforcement in the vehicle width direction. Thus, the reaction force generated at the contact portion between the front side member and the bumper reinforcement can be increased, and the vehicle can be rapidly released from the collision body at the time of small overlap collision of the vehicle.

In the vehicle front structure of the above aspect,
the ends of the framework portions on the vehicle front side are each provided with a crash box extending from the framework portion to the vehicle front side, and
the high rigidity portion is a joint portion between the end of the framework portion on the vehicle front side and the crash box.

In the vehicle front structure of the above aspect, the joint portion to the crash box is provided as the high rigidity portion at the end of the framework portion on the vehicle front side. Thus, the end of the bumper reinforcement in the vehicle width direction is bent inward in the vehicle width direction at the time of small overlap collision between the vehicle and a collision body. Then, the end of the bumper reinforcement in the vehicle width direction comes into contact with the joint portion between the framework portion and the crash box, and the reaction force generated at the contact portion can be increased effectively.

In the vehicle front structure of the above aspect,
a suspension member is supported from a vehicle lower side on each of the framework portions, and
the high rigidity portion is a joint portion between the end of the framework portion on the vehicle front side and the suspension member.

In the vehicle front structure of the above aspect, the joint portion to the suspension member is provided as the high rigidity portion at the end of the framework portion on the vehicle front side. Thus, the end of the bumper reinforcement in the vehicle width direction is bent inward in the vehicle width direction at the time of small overlap collision between the vehicle and a collision body. Then, the end of the bumper reinforcement in the vehicle width direction comes into contact with the joint portion between the framework portion and the suspension member, and the reaction force generated at the contact portion can be increased effectively.

As described above, in the vehicle front structure according to the present disclosure, it is possible to suppress the increase in the cost of the member and the mass of the vehicle body, and efficiently release the vehicle from a collision body at the time of small overlap collision of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle front structure according to the present embodiment is applied as viewed from a left oblique front side, and is a perspective view schematically illustrating an example of a main portion of a vehicle front portion;

FIG. 2 is an exploded perspective view schematically illustrating an end portion of the framework portion on the vehicle front side according to the present embodiment;

FIG. 3 is a partial plan view schematically showing a state in which a part of a vehicle to which the vehicle front structure according to the present embodiment is applied is viewed from an upper side of the vehicle, and a small overlap collision with the collision body is performed; and

FIG. 4 is a view schematically illustrating a state in which the framework portion is cut along line 4-4 of FIG. 3.

### DETAILED DESCRIPTION OF EMBODIMENTS

Hereinafter, a vehicle front structure according to the present embodiment will be described with reference to the drawings. Note that an arrow FR appropriately shown in the drawings indicates a front side in the vehicle front-rear direction, and an arrow UP indicates an upper side in the vehicle up-down direction. The arrow LH indicates the left side in the vehicle width direction, and in the present embodiment, indicates the outer side in the vehicle width direction. Hereinafter, in the case of simply describing the front-rear direction, the up-down direction, and the left-right direction, the front-rear direction of the vehicle front-rear direction, the up-down direction of the vehicle up-down direction, and the left-right direction of the vehicle (the vehicle width direction) are shown unless otherwise specified.

Note that, unless otherwise specified in the specification, each element is not limited to one, and a plurality of elements may be present. In addition, in the drawings, substantially the same elements are denoted by the same reference numerals, and redundant description in the specification is omitted.

### Schematic Configuration of the Front Portion of the Vehicle

First, the vehicle 12 to which the vehicle front structure 10 according to the present embodiment is applied will be described. For example, the vehicles 12 are battery electric vehicle and fuel cell electric vehicle having power units including motors, engines, and the like as drive sources. Battery electric vehicle and fuel cell electric vehicle are driven by the power generated by the power unit.

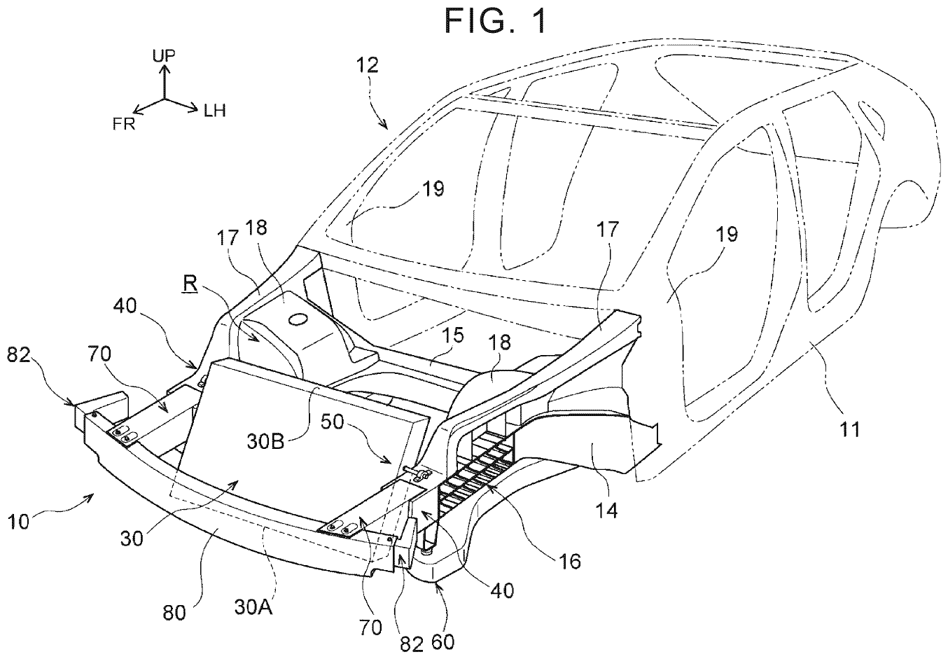

FIG. 1 is a perspective view of a vehicle 12 viewed from a left obliquely front side. FIG. 1 schematically illustrates a main part of a skeleton at a front portion of a vehicle 12 and a radiator 30 disposed in a power unit room R provided at a front portion of the vehicle 12. As illustrated in FIG. 1, a front side member 16, a suspension member 60, a bumper reinforcement 80, and the like are provided at a front portion of the vehicle 12 as a framework portion of the vehicle 12.

The front side members 16 are provided on both side portions of the vehicle front portion in the vehicle width direction, and extend along the vehicle front-rear direction. A power unit (not shown) is disposed between the left and right front side members 16. The power unit is supported from the lower side by a suspension member 60. The suspension member 60 is disposed on the vehicle lower side of the left and right front side members 16. The front end portion and the rear end portion of the suspension member 60 are attached to the left and right front side members 16 from the lower side at both end portions in the vehicle width direction.

A crash box 70 capable of absorbing impact energy extends from the front side member 16 toward the vehicle front side at an end portion of the left and right front side members 16 on the vehicle front side. A bumper reinforcement 80, which is a framework portion of the front bumper, extends along the vehicle width direction at the front ends of the left and right crash boxes 70.

Although the front side member 16 and the crash box 70 are described as separate components, they may be integrated.

On the other hand, a wheel house 14 in which wheels (not shown) are arranged is provided on the rear side of the left and right front side members 16, and the right wheel house 14 and the left wheel house 14 are connected by a cross member 15.

Further, an apron upper member 17 is disposed on the outer side of the front side member 16 in the vehicle width direction and on the upper side in the vehicle up-down direction. The apron upper member 17 is a framework portion constituting a skeleton on the upper side in the front portion of the vehicle 12. The apron upper 17 extends along the front side member 16 in the vehicle front-rear direction, and a rear end portion of the apron upper member 17 is coupled to the front pillar 19. A suspension tower 18 is integrally formed with the apron upper member 17. On the rear side of the wheel house 14 in the vehicle front-rear direction, a rocker 11 extending along the vehicle front-rear direction and constituting the skeleton of the vehicle body side portion is provided.

In the present embodiment, the left and right front side members 16, the left and right wheel houses 14 and the cross member 15, the apron upper 17, and the suspension tower 18 are integrally formed by casting using an aluminum alloy, a magnesium alloy, or the like as a material.

Accordingly, each member of the front side member 16, the left and right wheel houses 14, the cross member 15, the apron upper 17, and the suspension tower 18 has an open cross section that is opened in the die cutting direction during casting. Note that in the present embodiment, one and the other in the vehicle width direction can be the die cutting direction. Therefore, the cross section of each member is an open cross section that is open in at least one of the vehicle width directions.

All or part of the front side member 16, the left and right wheel houses 14, the cross member 15, the apron upper 17, and the suspension tower 18 may be formed as separate components.

The main components of the front side member 16, the suspension member 60, the radiator 30, and the bumper reinforcement 80 will be described in detail below.

### Front Side Member

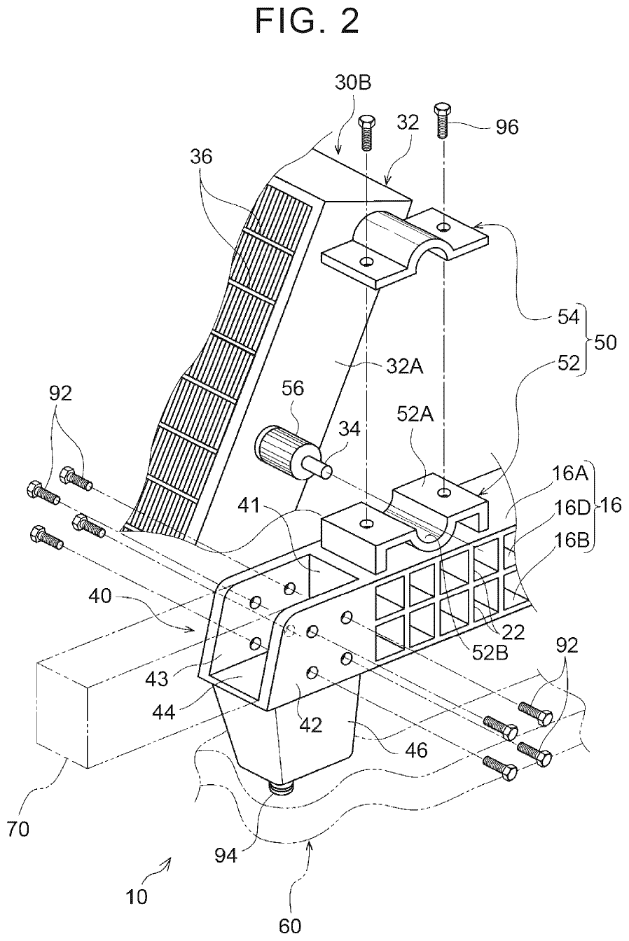

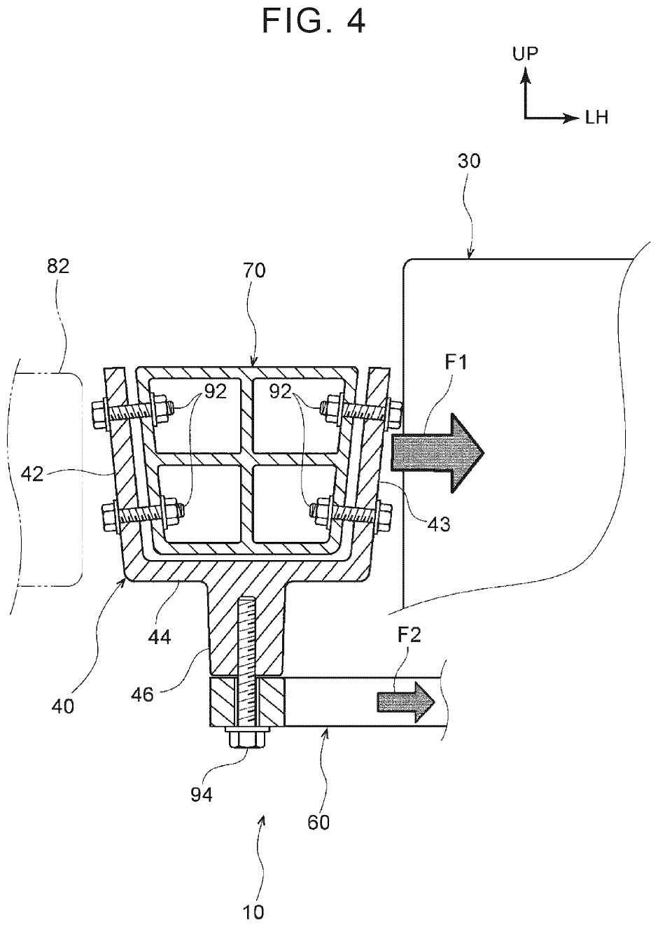

FIG. 2 is an exploded perspective view schematically illustrating an end portion of the front side member 16 on the vehicle front side. As shown in FIG. 2, the front side member 16 extends along the vehicle front-rear direction as described above. The front side member 16 includes an upper wall portion 16A, a lower wall portion 16B, an inner wall portion 16C (see FIG. 4), and a partition wall portion 16D. The front side member 16 has a substantially E-shaped open cross section that is open outward in the vehicle width direction. The upper wall portion 16A constitutes an upper wall of the front side member 16. The lower wall portion 16B constitutes a lower wall of the front side member 16. The inner wall portion 16C constitutes an inner wall connecting an inner end portion of the upper wall portion 16A in the vehicle width direction and an inner end portion of the lower wall portion 16B in the vehicle width direction. The partition wall portion 16D is erected from an intermediate portion of the inner wall portion 16C in the vehicle vertical direction to an outer side in the vehicle lateral direction, and partitions the inner space of the front side member 16 into two rows in the vertical direction.

In the front side member 16, a plurality of ribs 22 are provided along the longitudinal direction of the vehicle in the upper and lower rows separated by the partition wall portion 16D. As a result, the internal space of each column is partitioned into a plurality of rooms, and the open cross section of the front side member 16 is reinforced. When a collision load is input to the front side member 16 from the vehicle front side, a plurality of rooms formed in the upper and lower rows of the front side member 16 are destroyed in order from the vehicle front side, and a destructive load is generated. In this process, the impact load is absorbed. In the front side member 16, the positions of the ribs 22 provided in the upper row and the ribs 22 provided in the lower row may coincide with each other in the vehicle front-rear direction or may be different from each other. The following arrangement is preferable from the viewpoint of reducing the load difference of the breaking load generated by the time difference by shifting the collapse timings of the ribs 22 in the upper and lower rows. That is, it is preferable that the ribs 22 provided in the upper row and the ribs 22 provided in the lower row are arranged so as to have different positions in the vehicle front-rear direction.

Further, at an end portion of the front side member 16 on the vehicle front side, a joint portion 40 as a high-rigidity portion having higher rigidity than other regions is provided. The joint portion 40 serves as a joint portion between the front side member 16 and the crash box 70, and serves as a joint portion between the front side member 16 and the suspension member 60. In the present embodiment, the front side member 16 and the joint portion 40 are integrated by casting.

The joint portion 40 includes a first wall portion 41, a second wall portion 42, a third wall portion 43, and a fourth wall portion 44. The first wall portion 41 has a main surface in which the vehicle front-rear direction is a plate thickness direction and faces the vehicle front-rear direction. An upper wall portion 16A, a lower wall portion 16B, an inner wall portion 16C, and a front end portion of the partition wall portion 16D of the front side member 16 are connected to the main surface constituting the rear surface of the first wall portion 41. On the other hand, an end portion of a crash box 70, which will be described later, on the vehicle rear side is connected to a main surface constituting the front surface of the first wall portion 41.

The second wall portion 42 is connected to an end portion of the first wall portion 41 on the outer side in the vehicle width direction, and extends toward the vehicle front side. The second wall portion 42 has a main surface that faces in the vehicle width direction, with the vehicle width direction being a plate thickness direction. The main surface of the second wall portion 42 on the inner side in the vehicle width direction is disposed so as to face the outer surface (not shown) of the crash box 70 on the outer side in the vehicle width direction. The second wall portion 42 is joined to the outer surface of the crash box 70 via the fastening member 92. The fastening member 92 is, for example, a weld nut welded to the inside of the crash box 70 and a bolt that penetrates the second wall portion 42 and the outer surface of the crash box 70 and is screwed to the weld nut.

The third wall portion 43 is connected to an end portion of the first wall portion 41 on the inner side in the vehicle width direction, and extends toward the vehicle front side. The third wall portion 43 has a main surface that faces in the vehicle width direction, with the vehicle width direction being a plate thickness direction. The main surface of the third wall portion 43 on the outer side in the vehicle width direction is disposed so as to face the inner side surface (not shown) on the inner side in the vehicle width direction of the crash box 70. Like the second wall portion 42, the third wall portion 43 is joined to the inner surface of the crash box 70 via the fastening member 92.

In this way, both side surfaces of the crash box 70 in the vehicle width direction are connected to the end portion of the front side member 16 on the vehicle front side via the second wall portion 42 and the third wall portion 43 of the joint portion 40. The crash box 70 may be welded to the joint portion 40.

The fourth wall portion 44 of the joint portion 40 is connected to an end portion of the first wall portion 41 on the vehicle lower side, and extends toward the vehicle front side. The fourth wall portion 44 has a main surface that faces the vehicle downward direction, with the vehicle vertical direction being the plate thickness direction. An end portion of the crash box 70 on the vehicle rear side is placed on the main surface constituting the upper surface of the fourth wall portion 44.

Here, an attachment portion 46 fixed to the suspension member 60 is provided on the lower surface of the fourth wall portion 44. The attachment portion 46 is formed as a mount portion integrally formed on the lower surface of the fourth wall portion 44, and is provided so as to protrude from the lower surface of the fourth wall portion 44 toward the vehicle lower side. The attachment portion 46 is disposed so as to face the end portion of the suspension member 60 on the vehicle front side and the left and right end portions on the outside in the vehicle width direction, and is joined to the suspension member 60 via the fastening member 94. The fastening member 94 is, for example, a bolt that penetrates the suspension member 60 and is screwed into an internal thread formed in the attachment portion 46. Here, the joint portion 40 and the attachment portion 46 are configured to be integrated, but may be configured as a separate component.

### Suspension Member

As described above, the end portion of the suspension member 60 on the vehicle front side and the end portion on the vehicle rear side are attached to the left and right front side members 16 from the lower side at both end portions in the vehicle width direction. The end portion of the suspension member 60 on the vehicle front side constitutes a cross member extending in the vehicle width direction, and both end portions in the vehicle width direction are joined to the lower surfaces of the left and right front side members 16 via the attachment portions 46. In this way, the suspension member 60 is supported by the pair of front side members 16 from the vehicle lower side.

### Radiator

The radiator 30 serving as a heat exchanger is disposed between the pair of front side members 16 on the upper side of the front portion of the suspension member 60 in the vehicle front-rear direction. The radiator 30 of the present embodiment is mounted in an inclined attitude such that the end portion 30A on the vehicle lower side protrudes toward the vehicle front side from the end portion 30B on the vehicle upper side. Although not shown, a cylindrical fan shroud, an electric fan, and the like for guiding the air introduced from the radiator 30 to the vehicle rear side are disposed behind the radiator 30.

The radiator 30 is, for example, a plate-shaped structure flat in the vehicle front-rear direction, and includes a radiator support 32 formed in a substantially rectangular frame shape in the vehicle front-rear direction, and a refrigerant pipe 36 supported by the radiator support 32. The refrigerant pipe 36 is provided in a meandering manner so as to reciprocate a plurality of times in the vehicle width direction between the left and right side surfaces of the radiator support 32. A plurality of fins (not shown) is attached to the refrigerant pipe 36. During traveling of the vehicle 12, the atmosphere introduced into the inside of the power unit room R through a front grille (not shown) passes between the fins, and cools the refrigerant inside the refrigerant pipe. The refrigerant pipe circulates, for example, in a flow path inside a battery stack (not shown) for storing electric power serving as a driving source when the vehicle travels, and the refrigerant pumped by a pump (not shown) circulates inside the battery stack through the refrigerant pipe and exchanges heat. Thus, the battery stack is cooled. The refrigerant pipe may be configured to circulate with a flow path inside the power unit.

In the radiator 30, an end portion of the radiator support 32 on the outer side in the vehicle width direction is supported by the pair of front side members 16 via the support portion 50. Specifically, the radiator support 32 includes a cylindrical rotation shaft 34 that protrudes outward from the side surface 32A in the vehicle width direction in the vehicle width direction. The support portion 50 is disposed on the vehicle rear side of the joint portion 40 of the front side member 16, and rotatably supports the radiator 30 around the axis of the rotation shaft 34 protruding from the radiator support 32.

The support portion 50 includes a support base 52 joined to the upper surface of the front side member 16 and a bearing portion 54 overlapped on the upper side of the support base 52. The support base 52 is formed of a bracket having a substantially rectangular shape when viewed from the vehicle upper side, and is welded to the upper surface of the front side member 16. In addition, the support base 52 is formed with a pedestal portion 52A that is curved so as to be convex toward the vehicle upper side at two places on the vehicle front side and the vehicle rear side. Between the pair of front and rear pedestal portions 52A, an arc-shaped support surface 52B recessed downward is formed.

The bearing portion 54 is formed of brackets having a substantially rectangular shape when viewed from the vehicle upper side, and is fastened to the pedestal portion 52A of the support base 52 with fastening members 96 at two places on the vehicle front side and the vehicle rear side. The fastening member 96, for example, penetrates the bearing portion 54 and is screwed into a weld nut (not shown) welded to the lower surface of the pedestal portion 52A of the support base 52. In addition, an arc-shaped curved portion 54A that is curved so as to be convex toward the vehicle upper side is formed in an intermediate portion of the bearing portion 54 in the vehicle front-rear direction.

When the bearing portion 54 is fixed to the upper surface of the support base 52, a substantially cylindrical bearing is formed by the support surface 52B of the support base 52 and the curved portion 54A of the bearing portion 54. The rotation shaft 34 of the radiator 30 is inserted into the bearing, and the radiator 30 is rotatably supported. In the present embodiment, an elastic portion 56 made of rubber for vibration isolation is provided between the rotation shaft 34 and the substantially cylindrical bearing.

On the other hand, in the radiator 30, an end portion of the radiator support 32 on the vehicle lower side is supported via a cross member (not shown) extending in the vehicle width direction. The cross member is, for example, a lower absorber. In the lower absorber, a portion on the vehicle front side is fixed to a bottom portion of a front bumper cover (not shown) by fixing means such as bolt fastening, and a portion on the vehicle front side is fixed to an end portion on the vehicle lower side of the radiator support 32 by bolt fastening or the like.

When a collision load is applied to the cross member at the time of a front collision of the vehicle 12, the radiator 30 is pressed to the vehicle rear side together with the cross member. Further, by the input of the collision load, the fixing of the cross member and the end portion of the radiator support 32 on the vehicle lower side is released. As a result, the radiator 30 is rotated around the axis of the rotation shaft 34, and the portion of the radiator 30 on the vehicle lower side is retracted toward the vehicle rear side by the rotation, whereby the radiator 30 can be protected from the collision body.

### Bumper Reinforcement

The bumper reinforcement 80 is a hollow beam-shaped framework portion and extends along the vehicle width direction. The bumper reinforcement 80 is connected in a state in which an end portion on the outside in the vehicle width direction protrudes outward in the vehicle width direction beyond an end portion on the vehicle front side of the crash box 70. In addition, the bumper reinforcement 80 is gently curved such that an intermediate portion in the vehicle width direction is convex toward the vehicle front side in a plan view.

Here, a protruding portion 82 protruding toward the vehicle rear side and toward the vehicle width direction inner side is provided at an end portion of the bumper reinforcement 80 on the vehicle width direction outer side. Here, the bumper reinforcement 80 and the protruding portion 82 are described as separate components, but they may be integrally formed.

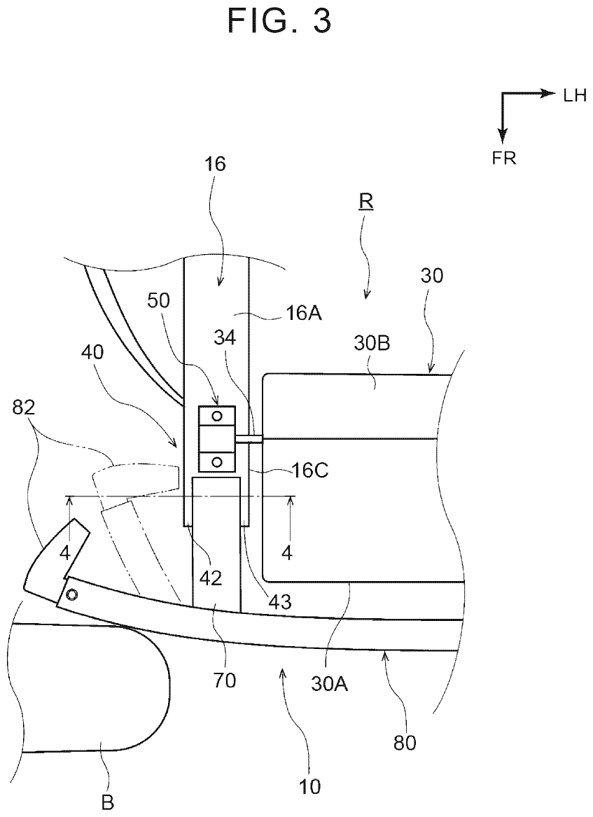

FIG. 3 is a partial plan view schematically illustrating a state in which the vehicle 12 is subjected to a small overlap collision with the collision body B. As shown in FIG. 3, when the vehicle 12 makes a small overlap collision with the collision body B, a collision load mainly toward the rear of the vehicle is input to an end portion of the bumper reinforcement 80 in the vehicle width direction. Then, the end portion of the bumper reinforcement 80 in the vehicle width direction is bent and deformed inward in the vehicle width direction. In this state, as indicated by a two-dot chain line in FIG. 3, the protruding portion 82 provided at the end portion of the bumper reinforcement 80 in the vehicle width direction abuts against one of the front side members 16. In FIG. 3, one of the front side members 16 is a front side member 16 disposed on the right side.

In a state in which the end portion of the bumper reinforcement 80 in the vehicle width direction is bent and deformed, the protruding portion 82 and a part of the radiator 30 are arranged so as to overlap with each other in the vehicle width direction with the front side member 16 interposed therebetween. Further, in the front side member 16, a joint portion 40 is disposed in a region between the protruding portion 82 and the radiator 30. As a result, as shown in FIG. 4, the component force F1 of the impact load transmitted through the protruding portion 82 to the vehicle-width-direction inner side is transmitted to the high-rigidity portion of the one front side member 16. Thereafter, the component force of the collision load inward in the vehicle width direction is transmitted from one front side member 16 to the other front side member 16 via the radiator 30. As a result, a reaction force is generated at a contact portion between one of the front side members 16 and the bumper reinforcement 80 by utilizing the bending rigidity of the pair of front side members 16 and the radiator 30.

### Action and Effect

As described above, in the vehicle front structure 10 according to the present embodiment, the bumper reinforcement 80 is connected to an end portion of the pair of front side members 16 extending in the vehicle front-rear direction on the vehicle front side. The bumper reinforcement 80 extends along the vehicle width direction, and is connected in a state in which an end portion on the outer side in the vehicle width direction protrudes outward in the vehicle width direction beyond an end portion on the vehicle front side of the front side member 16.

Here, a radiator 30 as a heat exchanger is provided between the pair of front side members 16. The radiator 30 is disposed so as to overlap the end portion of the bumper reinforcement 80 in the vehicle width direction in a state where the end portion on the vehicle width direction outer side is bent and deformed by the input of the collision load from the vehicle front side.

Therefore, as shown in FIG. 3, when the vehicle 12 makes a small overlap collision with the collision body B, a collision load mainly toward the rear of the vehicle is input to an end portion of the bumper reinforcement 80 in the vehicle width direction. Then, the end portion of the bumper reinforcement 80 in the vehicle width direction is bent and deformed inward in the vehicle width direction and comes into contact with one of the front side members 16. Then, as shown in FIG. 4, the component force F1 of the impact load toward the vehicle-width-direction inner side is transmitted from one of the front side members 16 to the other of the front side members 16 via the radiator 30. As a result, a reaction force is generated at the contact portion between the front side member 16 and the bumper reinforcement 80 by utilizing the bending rigidity of the front side member 16 and the radiator 30, and a lateral force to the anti-collision side (the vehicle width direction inner side) acts on the vehicle front portion. Accordingly, the vehicle 12 can be efficiently released from the collision body B at the time of a small overlap collision of the vehicle 12. Further, by utilizing the bending rigidity of the radiator 30 known as a member mounted on the front of the vehicle, it is not necessary to add a dedicated coupling member corresponding to the small overlap collision. Therefore, it is possible to suppress an increase in the cost of the member and the mass of the vehicle.

Further, in the present embodiment, when the vehicle 12 makes a small overlap collision with the collision body B, a collision load mainly toward the rear of the vehicle is input to an end portion of the bumper reinforcement in the vehicle width direction. Then, the protruding portion 82 provided at the end portion of the bumper reinforcement 80 in the vehicle width direction moves inward in the vehicle width direction and comes into contact with the front side member 16. As a result, the component force F1 of the impact load toward the vehicle-width-direction inner side is rapidly transmitted from one of the front side members 16 to the radiator 30 via the protruding portion 82. As a result, the vehicle 12 can quickly escape from the collision body B at the time of a small overlap collision of the vehicle 12.

Further, in the present embodiment, the pair of front side members 16 are provided with a joint portion 40 as a high rigidity portion in a region disposed between the end portion of the bumper reinforcement 80 subjected to bending deformation in the vehicle width direction and the radiator 30.

The joint portion 40 serves as a joint portion between an end portion of the front side member 16 on the vehicle front side and the crash box 70. As a result, when the vehicle 12 makes a small overlap collision with the collision body B, the end portion of the bumper reinforcement 80 in the vehicle width direction is bent and deformed inward in the vehicle width direction, and comes into contact with the joint portion 40 that joins the front side member 16 and the crash box 70. As a result, the component force of the impact load can be transmitted to the radiator 30 via the high-rigidity portion of the front side member 16 (see the component force F1 in FIG. 4).

The joint portion 40 serves as a joint portion between the vehicle front-side end portion of the pair of front side members 16 and the suspension member 60. As a result, when the vehicle 12 makes a small overlap collision with the collision body B, the end portion of the bumper reinforcement 80 in the vehicle width direction is bent and deformed inward in the vehicle width direction, and comes into contact with the joint portion 40 that joins the front side member 16 and the suspension member 60. As a result, the component force of the impact load can be transmitted to the suspension member 60 via the high-rigidity portion of the front side member 16 (see the component force F2 in FIG. 4). The vehicle-width-direction inner component force F2 transmitted through the joint portion 40 of one front side member 16 is transmitted to the other front side member 16 through the suspension member 60. Accordingly, by utilizing the bending rigidity of the front side member 16 and the suspension member 60, a reaction force can be generated at the contact portion between the front side member 16 and the bumper reinforcement 80. That is, in the present embodiment, the lateral force on the anti-collision side (the vehicle width direction inner side) acts on the vehicle front portion by utilizing the bending rigidity of the pair of front side members 16, the radiator 30, and the suspension member 60.

### Supplementary Explanation

Although the vehicle front structure according to the embodiment has been described above, the present disclosure is not limited thereto. For example, it is not essential that the front side member 16 has an open cross-section. The cross-sectional shape of the front side member 16 in a direction orthogonal to the extending direction may be a closed cross-section. Further, for example, it is not essential that the joint portion 40 is integrally formed at the end portion of the front side member 16 on the vehicle front side. The front side member 16 and the joint portion 40 may be configured as separate components.

What is claimed is:

1. A vehicle front structure comprising:
a pair of framework portions provided on both sides of a vehicle front portion in a vehicle width direction and extending in a vehicle front-rear direction;
a bumper reinforcement extending along the vehicle width direction and connected in a state in which outer ends in the vehicle width direction project outward in the vehicle width direction beyond ends of the framework portions on a vehicle front side; and
a heat exchanger provided between the framework portions and disposed to overlap, in the vehicle width direction, the outer end of the bumper reinforcement in the vehicle width direction in a state in which the outer end is bent by input of a collision load from the vehicle front side.

2. The vehicle front structure according to claim 1, wherein the outer ends of the bumper reinforcement in the vehicle width direction are provided with protruding portions that protrude to a vehicle rear side and to an inner side in the vehicle width direction.

3. The vehicle front structure according to claim 1, wherein the framework portions are each provided with, in an area located between the heat exchanger and the end of the bumper reinforcement in the vehicle width direction in a state in which the end is bent, a high rigidity portion having higher rigidity than rigidity of another area.

4. The vehicle front structure according to claim 3, wherein:
the ends of the framework portions on the vehicle front side are each provided with a crash box extending from the framework portion to the vehicle front side; and
the high rigidity portion is a joint portion between the end of the framework portion on the vehicle front side and the crash box.

5. The vehicle front structure according to claim 3, wherein:
a suspension member is supported from a vehicle lower side on each of the framework portions; and
the high rigidity portion is a joint portion between the end of the framework portion on the vehicle front side and the suspension member.
